(19) United States
(12) Patent Application Publication
(10) Pub. No.: US 2022/0069571 A1
(43) Pub. Date: Mar. 3, 2022

(54) ACTIVATION CIRCUIT WITH SURGE SUPPRESSION AND METHOD OF ACTIVATING CONVERSION APPARATUS

(71) Applicant: ASIAN POWER DEVICES INC., Taoyuan City (TW)

(72) Inventors: Yeu-Torng YAU, Taoyuan City (TW); Tsung-Liang HUNG, Taoyuan City (TW)

(21) Appl. No.: 17/123,666

(22) Filed: Dec. 16, 2020

(30) Foreign Application Priority Data
Sep. 1, 2020 (TW) 109129909

(51) Int. Cl. H02H 9/04; H02H 1/00

(52) U.S. Cl. CPC H02H 9/04; H02H 1/0007

(57) ABSTRACT

An activation circuit with surge suppression is coupled to an output capacitor of a conversion apparatus. The activation circuit includes a detection circuit, a control circuit, and a surge suppression switch. The detection circuit provides an input signal to the control circuit according to an AC voltage received by an input end of the conversion apparatus, and determines whether the AC voltage is in a zero-crossing range according to the input signal. When the AC voltage in the zero-crossing range, the control circuit controls the surge suppression switch to connect a current path between the output capacitor and a ground end so as to active the conversion apparatus.

### BACKGROUND

### Technical Field

The present disclosure relates to an activation circuit with surge suppression and a method of activating a conversion apparatus, and more particularly to an activation circuit with surge suppression and a method of activating a conversion apparatus to perform an activation process in a specific occasion.

### Description of Related Art

The statements in this section merely provide background information related to the present disclosure and do not necessarily constitute prior art.

Surge current refers to a transient current in a circuit, which is usually a transient current spike phenomenon. There are many situations of generating the surge current, for example but not limited to, when an electronic apparatus is struck by lightning or the input power is initially connected, and the most common situation is when the input power is initially connected. In order to prevent the electronic apparatus from being affected by the surge current when the input power is initially connected so that the internal components of the electronic apparatus are broken down and damaged, so the peak value of the surge current must be limited/suppressed when the electronic apparatus is initially activated.

In order to suppress the surge current of the electronic apparatus, the most common manner is to install a surge suppression resistor at the input end of the electronic apparatus to reduce the peak value of the surge current flowing through the surge suppression resistor. After the electronic apparatus is activated and the surge current disappears, however, the input current still continuously flows through the surge suppression resistor, thereby continuously consuming power and reducing the efficiency of the electronic apparatus. With the current industry increasingly demanding that electronic apparatuses must meet low power consumption, high power density, and high efficiency, it is necessary to improve this problem and it is necessary to limit the peak value of the surge current to avoid internal components of the electronic apparatus from being broken down and damaged.

Therefore, how to design an activation circuit with surge suppression and a method of activating a conversion apparatus to limit the peak value of the surge current and avoid the consumption of higher power after activating the electronic apparatus is a major topic for the inventors of the present disclosure.

### SUMMARY

In order to solve the above-mentioned problems, the present disclosure provides an activation circuit with surge suppression. The activation circuit with surge suppression includes a detection circuit, a control circuit, and a surge suppression switch. The detection circuit is coupled to an input end of the conversion apparatus, and receives an AC voltage. The control circuit is coupled to the detection circuit. The surge suppression switch is coupled to the control circuit and the output capacitor. The detection circuit provides an input signal to the control circuit according to the AC voltage, and determines whether the AC voltage is in a zero-crossing range according to the input signal. When the AC voltage is in the zero-crossing range, the control circuit controls the surge suppression switch to connect a current path between the output capacitor and a ground end so as to activate the conversion apparatus.

In order to solve the above-mentioned problems, the present disclosure provides a method of activating a conversion apparatus. The conversion apparatus includes an output capacitor. The method of activating the conversion apparatus includes steps of: detecting an AC voltage to provide an input signal, determining whether the AC voltage is in a zero-crossing range according to the input signal, and controlling a surge suppression switch to connect a current path between the output capacitor and a ground end when the AC voltage is in the zero-crossing range so as to activate the conversion apparatus.

The main purpose and effect of the present disclosure is that when the AC voltage is initially connected to the conversion apparatus, the activation circuit selects a specific occasion to perform the activation process according to the voltage value of the AC voltage. The AC voltage is detected by the activation circuit in the activation process, and the conversion apparatus is activated when the voltage value of the AC voltage is as much as possible the lowest (that is, when the voltage value of the AC voltage is at the zero-crossing point) so as to limit (suppress) the peak value of the surge current generated when the conversion apparatus is activated.

The secondary purpose and effect of the present disclosure is that only a single transistor connected to the output capacitor in series is used, which has reduced an electronic component (i.e., the resistor) compared to the conventional surge suppression circuit. Moreover, since the activation circuit can select the specific occasion to perform the activation process according to the voltage value of the AC voltage, the peak value of the surge current can be significantly limited (suppressed). If the peak value of the surge current is not large, the transistor with low withstand current can be used as the surge suppression switch, thereby significantly reducing the circuit cost and saving the circuit volume.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of an activation circuit with surge suppression applied to a conversion apparatus according to the present disclosure.

FIG. 2 are schematic waveforms of an AC voltage, an input current, and a control signal of the conversion apparatus.

FIG. 3 is a detail block circuit diagram of the activation circuit with surge suppression applied to a conversion apparatus according to the present disclosure.

FIG. 4 is a flowchart of a method of activating a conversion apparatus according to the present disclosure.

### DESCRIPTION

Reference will now be made to the drawing figures to describe the present disclosure in detail. It will be understood that the drawing figures and exemplified embodiments of present disclosure are not limited to the details thereof.

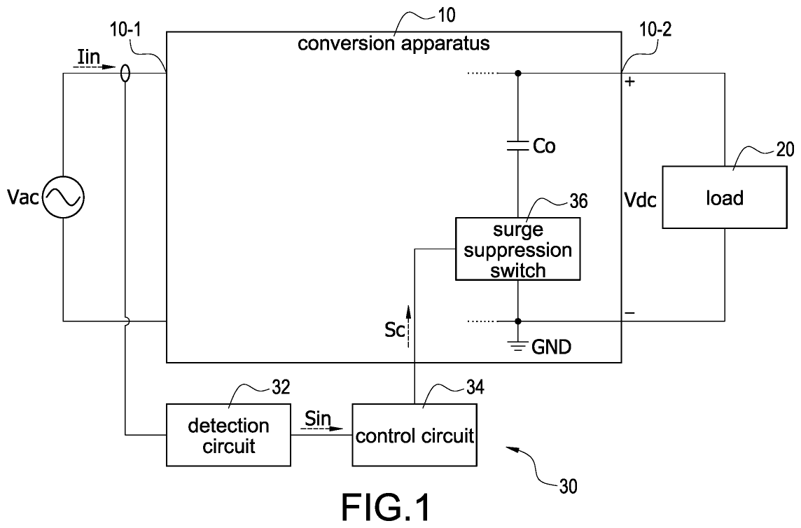

Please refer to FIG. 1, which shows a block circuit diagram of an activation circuit with surge suppression applied to a conversion apparatus according to the present disclosure. The conversion apparatus 10 includes an input end 10-1 and an output end 10-2, and an output capacitor Co of the conversion apparatus 10 is coupled between the output end 10-2 and a ground end GND. The conversion apparatus 10 receives an AC voltage Vac through the input end 10-1, and converts the AC voltage Vac into a DC voltage Vdc. The DC voltage Vdc is stored in the output capacitor Co. The output end 10-2 is coupled to a load 20, and the DC voltage Vdc stored in the output capacitor Co is supply power to the load 20 through the output end 10-2. An activation circuit 30 is coupled to the conversion apparatus 10, and is used to perform an activation process before the conversion apparatus 10 operates so that the conversion apparatus 10 can successfully operates after the activation process is performed.

The activation circuit 30 is coupled between the input end 10-1 and the output capacitor Co, and the activation circuit 30 incudes a detection circuit 32, a control circuit 34, and a surge suppression switch 36. One end of the detection circuit 32 receives the AC voltage Vac through the input end 10-1, and the other end of the detection circuit 32 is coupled to the control circuit 34. One end of the surge suppression switch 36 is coupled to the control circuit 34, and the other end of the surge suppression switch 36 is coupled to the output capacitor Co. The detection circuit 32 provides an input signal Sin to the control circuit 34 according to the AC voltage Vac, and the input signal Sin may be a proportional scaling-down signal to the AC voltage Vac. The control circuit 34 receives the input signal Sin and determines whether a voltage value of the AC voltage Vac is at a zero-crossing point according to the input signal Sin so that the control circuit 34 provides a control signal Sc to control (turn on or turn off) the surge suppression switch 36.

When the AC voltage Vac is initially connected to the conversion apparatus 10, the activation circuit 30 selects a specific occasion to perform the activation process according to the voltage value of the AC voltage Vac so that a surge current of the conversion apparatus 10 can be suppressed when the conversion apparatus 10 is activated. The specific occasion may be: when the AC voltage Vac is at the zero-crossing point, the control circuit 34 turns on the surge suppression switch 36 through the control signal Sc. At this condition, the output capacitor Co is charged since a current path Li between the output end 10-2 and the ground end GND is connected by turning on the surge suppression switch 36 so that the conversion apparatus 10 starts to operate and completes the activation process. When the AC voltage Vac is not at the zero-crossing point, the control circuit 34 turns off the surge suppression switch 36 by the control signal Sc. At this condition, the output capacitor Co fails to be charged since the current path Li between the output end 10-2 and the ground end GND is disconnected by turning off the surge suppression switch 36 so that the conversion apparatus 10 does not operate.

Furthermore, when the AC voltage Vac is not yet coupled to the conversion apparatus 10, the output capacitor Co does not store any electricity. At this condition, two ends of the output capacitor Co are close to a short circuit so that a path between the input end 10-1 and the ground end GND is close to a short circuit. When the AC voltage Vac is initially connected to the conversion apparatus 10, an input current Iin flowing through the input end 10-1 will instantly generate a higher current spike (also referred to as “surge current”) due to the short-circuit path. Since the excessive surge current will break down power components inside the conversion apparatus 10 to damage the power components, the activation process must be performed to suppress the peak value of the surge current before the conversion apparatus 10 is activated. Since the peak value of the surge current is related to the voltage value of the AC voltage Vac, the main purpose and effect of the present disclosure is that the AC voltage Vac is detected by the activation circuit in the activation process, and the conversion apparatus 10 is activated when the voltage value of the AC voltage Vac is as much as possible the lowest (that is, when the voltage value of the AC voltage Vac is at the zero-crossing point) so as to generate a lower surge current.

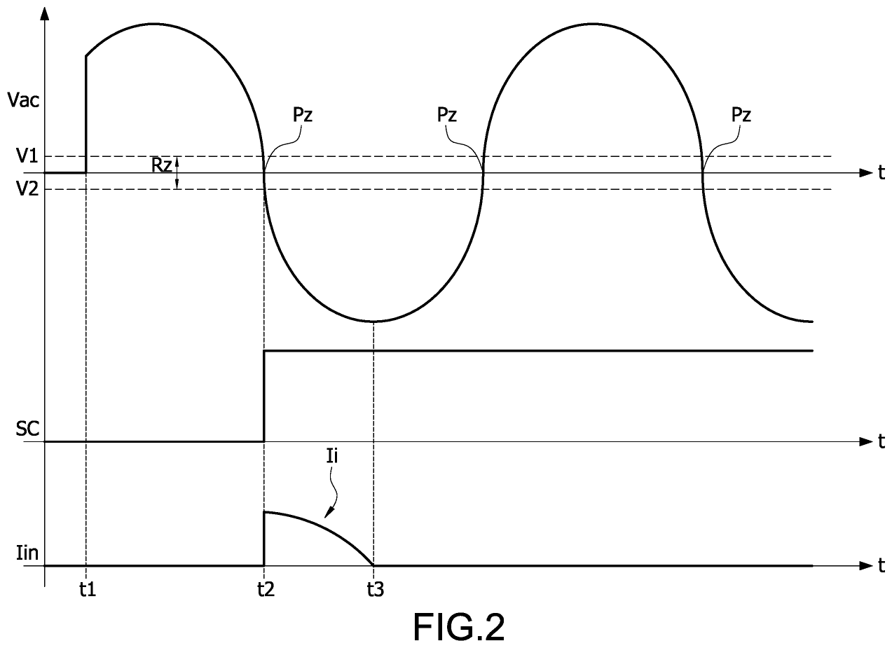

Please refer to FIG. 2, which shows schematic waveforms of the AC voltage, the input current, and the control signal of the conversion apparatus, and also refer to FIG. 1. A frequency of the AC voltage Vac is 60-Hz mains frequency. At time t1, the AC voltage Vac is initially connected to the input end 10-1, and therefore the detection circuit 32 detects the AC voltage Vac. Since the voltage value of the AC voltage Vac at this time is not at a zero-crossing point Pz, however, the control circuit 34 does not turn on the surge suppression switch 36 so that the output capacitor Co fails to be charged and the conversion apparatus 10 does not operate. At time t2, since the control circuit 34 determines that the voltage value of the AC voltage Vac is at the zero-crossing point Pz, the surge suppression switch 36 is turned on by the control signal Sc. At this condition, the path between the input end 10-1 and the ground end GND is connected and therefore a surge current Ii is generated (time t2 to time t3).

Since the voltage value of the AC voltage Vac at this time is at the zero-crossing point Pz, a peak value of the surge current Ii is still lower even if the current path Li between the output end 10-2 and the ground end GND is close to a short circuit. For example, the peak value of the surge current Ii can be suppressed below 30 amperes so that the peak value of the surge current Ii meets the requirements of safety regulations, such as UL, cUL, IEC, EN, and so on. During time t2 to time t3, since the DC voltage Vdc of the output capacitor Co has been gradually established, the surge current Ii disappears after time t3 so that the conversion apparatus 10 can normally operate and the activation process of the conversion apparatus 10 is completed.

In particular, the definition of the zero-crossing point Pz of the present disclosure can be expanded to a zero-crossing range with a small voltage difference, that is, no only the 0-volt voltage value is included. Specifically, the main point of the present disclosure is to select the specific occasion to perform the activation process according to the voltage value of the AC voltage Vac so that the peak value of the surge current Ii meets the requirements of safety regulations. In other words, as long as the peak value of the surge current Ii affected by the voltage value of the AC voltage Vac meets the requirements of safety regulations when the surge suppression switch 36 is turned on. For example but not limited to, as shown in FIG. 2, the surge suppression switch 36 is turned on when the voltage value of the AC voltage Vac is in a zero-crossing range Rz (voltage range) which is between an upper-limit voltage V1 (for example, +10 volts) and a lower-limit voltage V2 (for example, −10 volts). Also, in the zero-crossing range Rz, the surge current Ii generated by turning on the surge suppression switch 36 must meet the requirements of safety regulations. In particular, if the consideration of reducing the peak value of the surge current Ii as much as possible, the best occasion to turn on the surge suppression switch 36 is still at the zero-crossing point Pz.

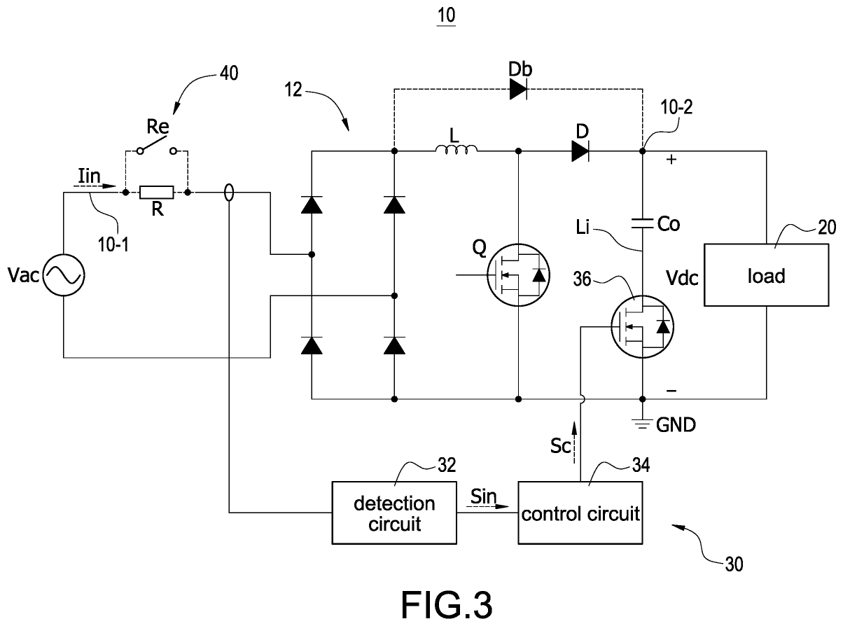

Please refer to FIG. 3, which shows a detail block circuit diagram of the activation circuit with surge suppression applied to a conversion apparatus according to the present disclosure, and also refer to FIG. 1 and FIG. 2. In this embodiment, the conversion apparatus 10 is, but not limited to, applied as a step-up converter. In other words, the conversion apparatus 10 can be applied as any type of converter well known to those skilled in the art. The conversion apparatus 10 includes a bridge rectifying circuit 12, a boost inductor L, a power switch Q, a diode D, and an output capacitor Co, and its circuit connection is well known to those skilled in the art, and will not be repeated here. The surge suppression switch 36 is a transistor and is connected to the output capacitor Co in series. In particular, the surge suppression switch 36 can be connected in series at any position of the current path Li between the output end 10-2 and the ground end GND. That is, the surge suppression switch 36 can be connected between the output capacitor Co and the ground end GND, or connected between the output end 10-2 and the output capacitor Co. When the current path Li is connected, the output capacitor Co starts to be charged to establish the DC voltage Vdc so as to complete the activation process. Once the current path Li is disconnected, the output capacitor Co cannot be charged.

In the existing technology, a conventional surge suppression circuit 40 (indicated by dashed lines) usually uses a relay Re and a resistor R connected to the relay Re in parallel to connect to the input end 10-1 of the conversion apparatus 10 to limit (suppress) the surge current Ii. When the conversion apparatus 10 activates, the relay Re is turned off so that the surge current Ii flowing through the resistor R is limited (suppressed). Afterward, in order to avoid the resistor R from continuously consuming energy when the conversion apparatus 10 operates, the relay Re is turned on so that no current flowing through the resistor R but flowing through the relay Re. Since the surge current Ii flowing through the relay Re is large (typically more than 50 amperes) when the conversion apparatus 10 activates, a transistor cannot withstand such a large surge current Ii. Therefore, the relay Re is used instead of the transistor, or a transistor with high withstand current is used. Regardless of whether the relay Re or the transistor with high withstand current is used, it is not favorable to the requirements of reducing circuit size and saving circuit cost. In addition, due to the high peak value of the surge current Ii, it is easy to break down the diode D which is good for high-speed switching, and therefore it is usually necessary to install a bypass diode Db (indicated by the dashed lines) with high withstand current so as to bypass the diode D when the conversion apparatus 10 is activated.

The present disclosure only uses a single transistor connected to the output capacitor Co in series, which has reduced an electronic component (i.e., the resistor R) compared to the conventional surge suppression circuit 40. Moreover, since the activation circuit 30 can select the specific occasion to perform the activation process according to the voltage value of the AC voltage Vac, the peak value of the surge current Ii can be significantly limited (suppressed). If the peak value of the surge current Ii is not large, the transistor with low withstand current (below 30 amperes) can be used as the surge suppression switch 36, thereby significantly reducing the circuit cost and saving the circuit volume.

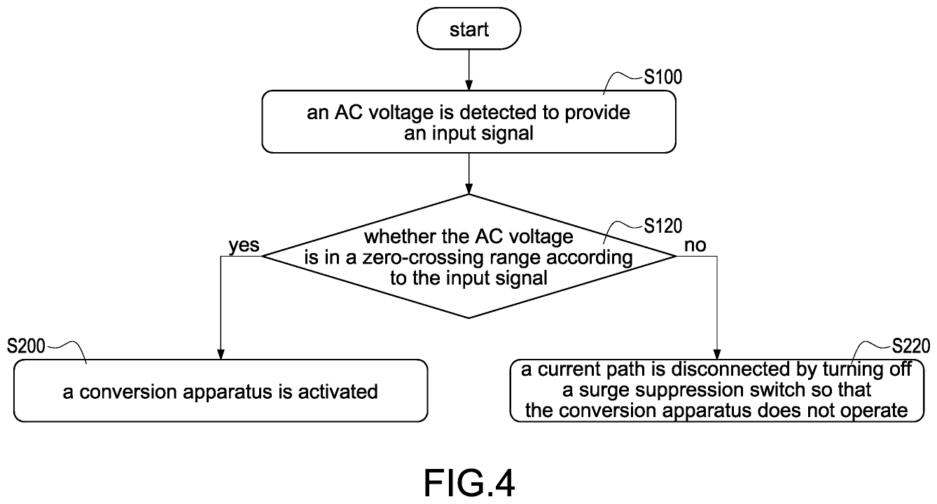

Please refer to FIG. 4, which shows a flowchart of a method of activating a conversion apparatus according to the present disclosure, and also refer to FIG. 1 to FIG. 3. The method of activating the conversion apparatus includes the following steps. An AC voltage is detected to provide an input signal (S100). The detection circuit 32 provides the input signal Sin to the control circuit 34 according to the AC voltage Vac. The input signal Sin is a proportional scaling-down signal to the AC voltage Vac. Afterward, the control circuit 34 determines whether the AC voltage is in a zero-crossing range according to the input signal (S120). The control circuit 34 receives the input signal Sin and determines whether the voltage value of the AC voltage Vac is near the zero-crossing point Pz according to the input signal Sin, that is, in a zero-crossing range Rz. The zero-crossing range Rz (voltage range) is, for example but not limited to, between an upper-limit voltage V1 (+10 volts of the AC voltage Vac) and a lower-limit voltage V2 (−10 volts of the AC voltage Vac). Also, in the zero-crossing range Rz, the surge current Ii generated by turning on the surge suppression switch 36 must meet the requirements of safety regulations. In particular, if the consideration of reducing the peak value of the surge current Ii as much as possible, the best occasion to turn on the surge suppression switch 36 is still at the zero-crossing point Pz.

Finally, when the AC voltage is in the zero-crossing range, the control circuit controls the surge suppression switch to connect a current path between the output capacitor and a ground end so as to active the conversion apparatus (S200). When the AC voltage Vac is in the zero-crossing range Rz, the control circuit 34 turns on the surge suppression switch 36 by the control signal Sc. At this condition, a current path Li between the output end 10-2 and the ground end GND is connected by turning on the surge suppression switch 36 so that the output capacitor Co is charged, and the conversion apparatus 10 starts to operate and completes the activation process. When the AC voltage is not at the zero-crossing point, the current path is disconnected by turning off the surge suppression switch so that the conversion apparatus does not operate (S220). The control circuit 34 turns off the surge suppression switch 36 by the control signal Sc. At this condition, the current path Li between the output end 10-2 and the ground end GND is disconnected by turning off the surge suppression switch 36 so that the output capacitor Co fails to be charged and the conversion apparatus 10 does not operate.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An activation circuit with surge suppression coupled to an output capacitor of a conversion apparatus, the activation circuit comprising:
a detection circuit coupled to an input end of the conversion apparatus, and configured to receive an AC voltage,
a control circuit coupled to the detection circuit, and
a surge suppression switch coupled to the control circuit and the output capacitor,
wherein the detection circuit provides an input signal to the control circuit according to the AC voltage, and determines whether the AC voltage is in a zero-crossing range according to the input signal; when the AC voltage is in the zero-crossing range, the control circuit controls the surge suppression switch to connect a current path between the output capacitor and a ground end so as to activate the conversion apparatus.

2. The activation circuit as claimed in claim 1, wherein when the control circuit turns on the surge suppression switch in the zero-crossing range, the AC voltage charges the output capacitor through the current path so that a peak value of a surge current flowing through the input end is less than a safety standard value.

3. The activation circuit as claimed in claim 1, wherein the zero-crossing range is a voltage range between an upper-limit voltage and a lower-limiting voltage of a voltage value of the AC voltage at a zero-crossing point.

4. The activation circuit as claimed in claim 1, wherein the zero-crossing range is a voltage value of the AC voltage at a zero-crossing point.

5. The activation circuit as claimed in claim 1, wherein the surge suppression switch is a transistor with a low withstand current.

6. The activation circuit as claimed in claim 1, wherein the surge suppression switch is connected to the capacitor in series.

7. The activation circuit as claimed in claim 1, wherein when the control circuit turns off the surge suppression switch, the current path is disconnected so that the conversion apparatus does not operate.

8. A method of activating a conversion apparatus, the conversion apparatus comprising an output capacitor, the method comprising steps of:
detecting an AC voltage to provide an input signal,
determining whether the AC voltage is in a zero-crossing range according to the input signal, and
controlling a surge suppression switch to connect a current path between the output capacitor and a ground end when the AC voltage is in the zero-crossing range so as to activate the conversion apparatus.

9. The method of activating the conversion apparatus as claimed in claim 8, further comprising a step of:
charging, by the AC voltage, the output capacitor through the current path when the surge suppression switch is in the zero-crossing range so that a peak value of a surge current flowing through an input end of the conversion apparatus is less than a safety standard value.

10. The method of activating the conversion apparatus as claimed in claim 8, further comprising a step of:
disconnecting the current path when the surge suppression switch is turned off so that the conversion apparatus does not activate.
